(19) United States
(12) Patent Application Publication
(10) Pub. No.: US 2023/0384752 A1
(43) Pub. Date: Nov. 30, 2023

(54) Control Strategy of Distributed Control Systems Based on Operator Actions

(71) Applicant: ABB Schweiz AG, Baden (CH)

(72) Inventors: Pablo Rodriguez, Birkenau (DE); Jens Doppelhamer, Ladenburg (DE); Benjamin Kloepper, Mannheim (DE); Reuben Borrison, Bruehl (DE); Marcel Dix, Allensbach (DE); Benedikt Schmidt, Heidelberg (DE); Hadil Abukwaik, Weinheim (DE); Arzam Muzaffar Kotriwala, Ladenburg (DE); Sylvia Maczey, Hirschberg (DE); Dawid Ziobro, Västerås (SE); Simon Hallstadius Linge, Västerås (SE); Marco Gaertler, Dossenheim (DE); Divyasheel Sharma, Bangalore (IN); Chandrika K R, Bangalore (IN); Gayathri Gopalakrishnan, Eskilstuna (SE); Matthias Berning, Worms (DE); Roland Braun, Niederkassel Lülsdorf (DE)

(73) Assignee: ABB Schweiz AG, Baden (CH)

(21) Appl. No.: 18/448,523

(22) Filed: Aug. 11, 2023

Related U.S. Application Data
(63) Continuation of application No. PCT/EP2022/050227, filed on Jan. 7, 2022.

(30) Foreign Application Priority Data
Feb. 12, 2021 (EP) 21156887.8

(51) Int. Cl. G05B 19/05

(52) U.S. Cl. CPC G05B 19/056; G05B 2219/1204

(57) ABSTRACT

A method includes acquiring state variables that characterize an operational state of an industrial plant; acquiring interaction events of a plant operator interacting with the distributed control system via a human-machine interface; determining based on the interaction events, and with state variables as input data, whether one or more interaction events are indicative of the plant operator executing a task that is not sufficiently covered by engineering of the distributed control system. When this determination is positive, mapping the input data to an amendment and/or augmentation for the engineering tool that has generated the application code.

### CROSS-REFERENCE TO RELATED APPLICATIONS

The instant application claims priority to International Patent Application No. PCT/EP2022/050277, filed Jan. 7, 2022, and to European Patent Application No. 21156887.8, filed Feb. 12, 2021, each of which is incorporated herein in its entirety by reference.

### FIELD OF THE DISCLOSURE

The present disclosure generally relates to automated control of industrial plants, and in particular plants with a distributed control system.

### BACKGROUND OF THE INVENTION

Automated control of industrial plants is usually performed according to an engineered control strategy that is to conduct normal operation of the plant in an efficient manner. However, such an engineered control strategy cannot foresee all situations that might arise during operation of the plant. In such situations, a plant operator may manually intervene and take control of the plant or a part thereof, overriding the engineered control strategy.

WO 2012/142 353 A1 discloses a method for monitoring a process control system. The method comprises visualizing key performance indicators, KPI, of the plant that are unsatisfactory.

### BRIEF SUMMARY OF THE INVENTION

In a general aspect, the present disclosure describes systems and methods that reduce the need for manual interventions during operation of an industrial plant, and/or the amount of time a plant operator has to spend on these interventions. The systems and methods include two computer-implemented methods for amending and/or augmenting an engineering tool for a distributed control system, and by another computer-implemented method for training a machine learning model.

The present disclosure describes two computer-implemented methods for amending and/or augmenting an engineering tool. The engineering tool is configured to generate application code. When this application code is executed on one or more controllers in a distributed control system of an industrial plant, will cause the industrial plant to be controlled according to a control strategy that is implemented in the application code.

Both methods produce an amendment and/or augmentation for the engineering tool that has generated the application code for the distributed control system. When the application code is re-generated by the amended and/or augmented engineering tool and executed in the distributed control system, the effect of the amendment is that the plant operator is likely to manually interact with the distributed control system less frequently, and/or to spend less time interacting with the distributed control system.

The first method obtains this amendment and/or augmentation based on past interaction events of a plant operator who interacts with the distributed control system of the plant via a human-machine interface. The second method obtains the amendment and/or augmentation based on a prediction of interaction events that a plant operator is likely to initiate based on the current state of the plant. This prediction is obtained from a trained machine learning model. The first method specifically facilitates the obtaining of the amendment and/or augmentation from known behavior patterns of a plant operator, whereas the second method specifically facilitates the obtaining of the amendment and/or augmentation from scratch without any a priori knowledge of behavior patterns.

During application of the first method, state variables that characterize an operational state of at least one industrial plant are acquired. Also, a set of interaction events of at least one plant operator interacting with the distributed control system of the industrial plant via a human-machine interface are acquired.

Based at least in part on the interaction events, the state variables, and optionally given engineering information of the distributed control system as input data, it is determined whether one or more interaction events are indicative of the plant operator executing a task that is not sufficiently covered by the engineering of the distributed control system. If this determination is positive, the input data is mapped to the sought amendment and/or augmentation for the engineering tool that has generated the application code for the distributed control system.

Control systems are designed based on requirement specifications during the engineering phase. But during this engineering phase, not every situation that will occur during operation of the plant can be foreseen. A human plant operator remains in the control loop as an interactive part to fill any gaps in the engineered control strategy. If a rare situation that is not foreseen in the control strategy and not very likely to reoccur is handled by intervention of the plant operator, this is a better way to go than amending the control strategy to handle this situation as well. But if it is likely that the situation will occur again, it is better to amend the engineering of the plant, to relieve the plant operator from having to execute the same, or a substantially similar, intervention time and time again. If the engineering is amended in an automated manner, this has multiple advantages:

The operation of the plant becomes safer because in every situation that can be handled automatically, correct operation no longer depends on the plant operator performing the right intervention at the appropriate time. Relieving the plant operator from routine interventions frees up time that would otherwise have been spent on these routine interventions for problem solving tasks that cannot be handled by machine. Knowledge of the plant operator is captured and documented in a form that is also transferable to similar plants.

It may be measured quantitatively how well the engineering of the plant covers the operating situations that actually occur in the plant.

The task that is not sufficiently covered by the present engineering of the distributed control system may be specified as a pattern in any suitable manner. In a particularly advantageous embodiment, the task that is not sufficiently covered by the present engineering of the distributed control system specifically comprises: manually executing a solution to an operational problem that is not covered by the present engineering of the distributed control system; and/or repeatedly executing one or more actions starting from equal or substantially similar operating states; and/or accessing at least one functionality that requires at least a threshold number of steps to access with at least a threshold frequency.

For example, in a waste incineration plant, the combustion process is very much dependent on the composition of the waste. The plant is engineered for a certain range of compositions, but a significant change in the composition that goes beyond this engineering may occur abruptly. For example, paper, plastics or some other material may be a normal constituent of household waste, so the engineering of the plant may presume that this constituent is always present. But updated environmental regulations may suddenly prescribe that the paper or plastic is to be collected in a separate bin for recycling, and suddenly this constituent is gone from the household waste. The plant operator may then notice that the combustion suddenly takes a turn for the worse and figure out how to improve the combustion by tweaking the air flow and the agitation of the waste inside the furnace. If this solution is incorporated into an updated engineering tool, and the engineering of the plant is updated accordingly, this solution may be re-used whenever waste of a similar composition is supplied to the plant in the future.

A situation where the plant operator has manually executed a solution to an operational problem may, for example, be detected by pattern recognition in state variable and interaction event data. For example, if there is a pattern where the state variables indicate a problematic or suboptimal state of the plant, a sequence of interaction events is subsequently detected, and in response to that, the state variables indicate an improvement in the state of the plant, it may be inferred that the intervention by the plant operator has solved an operational problem in the plant.

If one or more actions are repeatedly executed starting from equal or substantially similar operating states, then the engineering tool may be amended such that according to the new application code produced by this tool, the one or more actions are executed automatically in the future in response to the same or substantially similar operating state occurring again. This relieves the plant operator of repetitive manual work, similar to a macro recorder in a word processing program.

If at least functionality that requires at least a threshold number of steps to access with at least a threshold frequency, then the engineering tool may be amended such that the functionality is accessible with a fewer number of steps. For example, an arrangement of controls and displays in a human-machine interface may be too large to fit on a screen, and it may therefore be divided into several pages. The human-machine interface may be on page 1 by default, and to access a functionality that is on page 5, the plant operator may have to flip to page 2, 3, 4 and then 5. The initial assignment of controls and displays to the different pages may be motivated by an estimated probability that a plant operator may need to access the respective control or display. But in certain instances of the plant, some controls and displays may become more important than in other instances of the plant. This may even change at run-time. For example, if multiple residential neighbors of a plant complain to municipal authorities about noise, smell or another nuisance emanating from the plant, the plant operator may be compelled to reduce this nuisance. The respective sensor readings will have to be monitored more frequently, so it may be appropriate to move them from page 5 to page 1 where they are visible on the screen most of the time.

In these examples, situations where an amendment of the engineering tool is appropriate may be detected by searching or watching for specific patterns in data from the plant. But there may be more instances where it may emerge that there are “gaps” in the previous engineering of the plant that have to be filled by interventions of the plant operator. The invention therefore also provides a second computer-implemented method for amending and/or augmenting the engineering tool.

Akin to the first method, in the course of this second method, state variables that characterize an operational state of at least one industrial plant are acquired. At least one trained machine learning model is then used to predict, based on the state variables, one or more interaction events that at least one plant operator is likely to initiate on the distributed control system via a human-machine interface in response to the operational state. The one or more predicted interaction events are mapped to the amendment and/or augmentation for the engineering tool that has generated the application code for the distributed control system. Like in the first method, the amendment is configured such that, when the application code is re-generated by the amended and/or augmented engineering tool and executed in the distributed control system, the plant operator is likely to manually interact with the distributed control system less frequently, and/or to spend less time interacting with the distributed control system. The mapping may, for example, be performed by the machine learning model that also predicts interaction events, by another machine learning model, or in any other suitable manner.

Producing amendments and/or augmentations for the engineering tool in this manner does not require specific patterns for operating situations, and/or for interventions by a plant operator, to be known in advance. Rather, the engineering tool may learn from the plant operator dynamically and may also adapt to new classes of situations that were not foreseeable at the time of the initial engineering.

For example, a waste incineration plant that was previously operating optimally with a certain engineering may later be connected to a district heating network such that heat generated in the plant may be put to another use. From then on, it may become necessary to keep the amount and temperature of heat delivered to the district heating network within predetermined ranges to keep up the reliability of the district heating. These new goals may at least partially supersede previous goals. For example, to keep up heat delivery in case the calorific value of the waste drops, it may become necessary to fire a fuel-powered burner to supplement the combustion of the waste. According to the previous engineering, as long as it is not necessary for continued operation of the waste incineration plant, the burner would not have been fired because the fuel adds to the operating cost. The training of the machine learning model may capture that after connection to the district heating network, manual interventions have become necessary in an increasing number of situations. After training, the machine learning model may predict in which operating situations a manual intervention is likely to come. The engineering tool may then be amended so that according to the newly generated application code, the intervention to keep up the heat delivery may be initiated automatically in the future.

Both methods may be active in one and the same plant at the same time. That is, if it is detected according to known patterns that the engineering tool needs amending and/or augmenting in some place, this amendment and/or augmentation may be determined and implemented. On top of that, a machine learning model may be used to generate amendments and/or augmentations from interventions that do not fit into a previously known pattern.

The input data that is used in either method may, for example, further comprise one or more of: alarms and events reported by the distributed control system; a topology model of the industrial plant; a layout of a human-machine interface of the distributed control system; and a control logic of the distributed control system. If the input data is more detailed, then more elaborate patterns for the detection of “gaps” in the current engineering may be used, and/or the machine learning model may more accurately predict plant operator interventions.

### BRIEF DESCRIPTION OF THE SEVERAL VIEWS OF THE DRAWING(S)

FIG. 1 is a flowchart for two methods in accordance with the disclosure.

FIGS. 2a and 2b are flowcharts of information in accordance with the methods shown in FIG. 1.

FIG. 3 is a flowchart for a method of training a machine learning model in accordance with the disclosure.

### DETAILED DESCRIPTION OF THE INVENTION

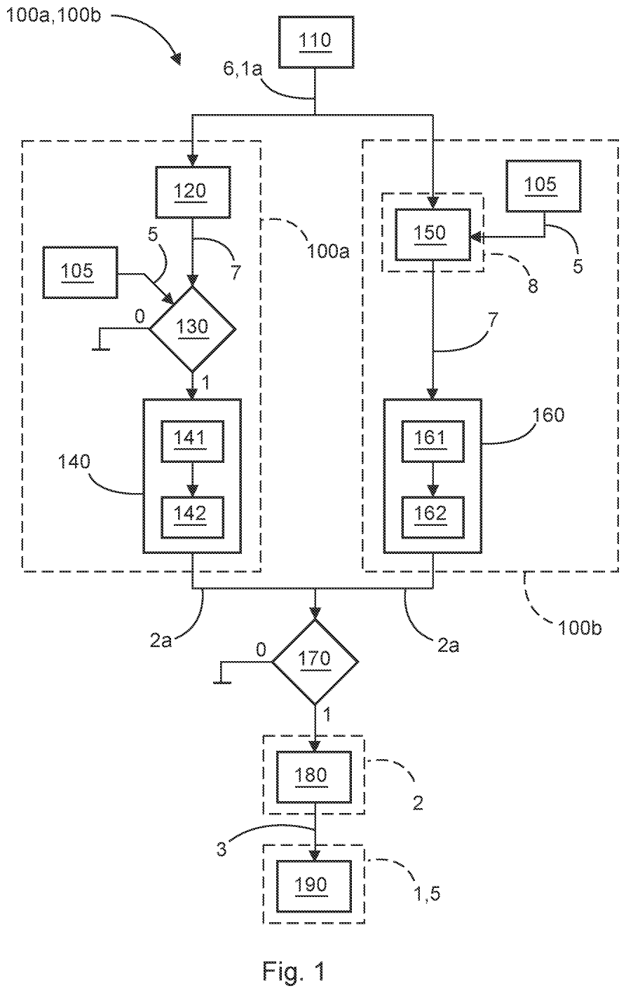

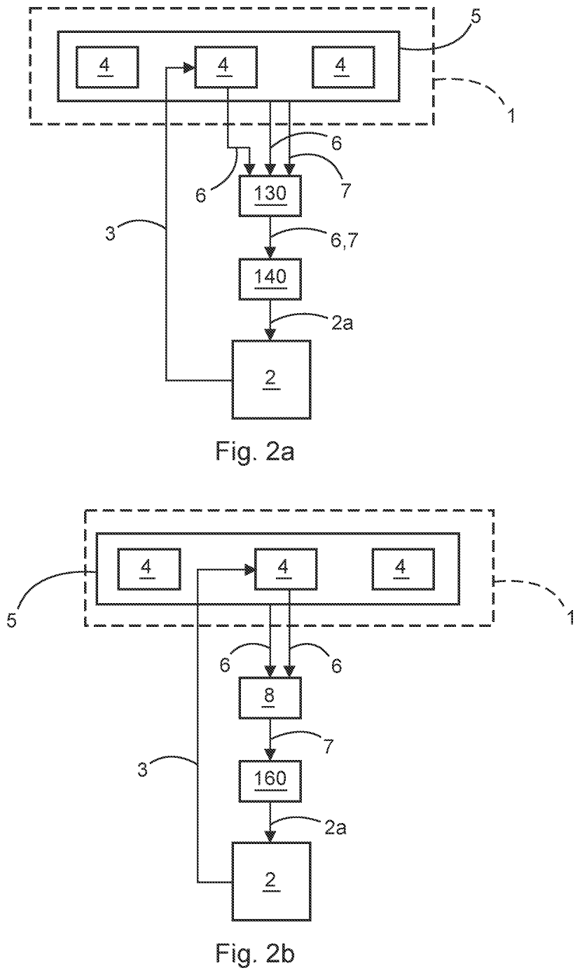

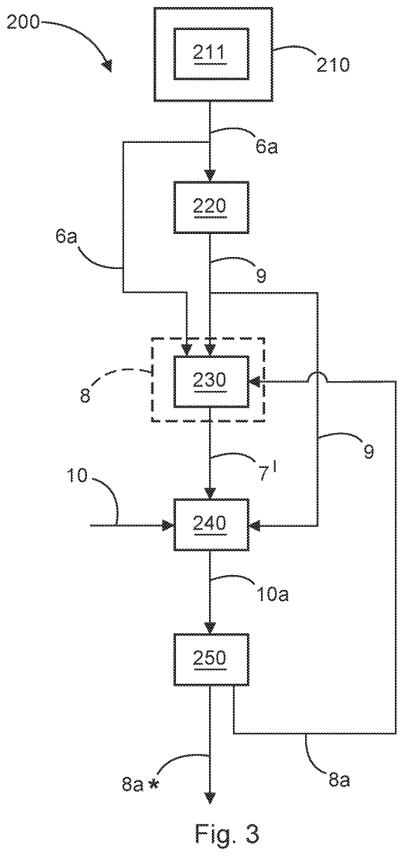

FIG. 1 shows exemplary embodiments of methods 100a, 100b for amending and/or augmenting an engineering tool 2; FIGS. 2a and 2b show exemplary flows of information according to methods 100a (FIGS. 2a) and 100b (FIG. 2b); FIG. 3 is a flowchart for an exemplary embodiment of a method 200 for training a machine learning model 8 for use in the method 100b.

FIG. 1 is a schematic flow chart of an embodiment of the methods 100a, 100b for amending and/or augmenting an engineering tool 2. Both methods 100a, 100b start with acquiring state variables 6 that characterize an operational state 1a of at least one industrial plant 1 in step 110.

In the course of method 110a, in step 120, a set of interaction events 7 of at least one plant operator interacting with the distributed control system 5 of the industrial plant 1 via a human-machine interface is acquired. In step 130, based at least in part on the interaction events 7, the state variables 6, and optionally given engineering information of the distributed control system 5, as input data, it is determined whether one or more interaction events 7 are indicative of the plant operator executing a task that is not sufficiently covered by the present engineering of the distributed control system 5. If this is the case (truth value 1), in step 140, the input data is mapped to an amendment and/or augmentation 2a for the engineering tool 2 that has generated the application code 3 for the distributed control system 5.

In the course of method 110b, in step 150, based on the state variables 6, one or more interaction events 7 that at least one plant operator is likely to initiate on the distributed control system 5 via a human-machine interface in response to the operational state 1a of the plant 1 is predicted using at least one machine learning model 8. In step 160, the one or more predicted interaction events 7 are mapped to an amendment and/or augmentation 2a for the engineering tool 2 that has generated the application code 3 for the distributed control system 5.

During the mapping 140, 160, performed in either method 110a or 100b, according to block 141 (respectively 161), a function in a given control library that accomplishes a result substantially similar to the result of a detected and/or predicted action or sequence of actions may be determined. According to block 142, respectively 162, this action or sequence of actions may be substituted with a call to the determined function in the control library. In this manner, if the plant operator does something manually for which there is already a library function available, the tried-and-tested library function is used.

According to block 105, for both methods 100a and 100b, an engineering tool 2 may be chosen that is configured to: assemble the distributed control system (5) from building blocks in a predetermined catalogue, wherein at least one such building block is a programmable logic controller, PLC; and generate application code that comprises control code for this PLC.

In the course of both methods 100a and 100b, the amendment 2a for the engineering tool 2 may be presented to a control operator for approval in step 170. If approval is granted (truth value 1), the engineering tool 2 may re-generate the application code 3 for the distributed control system 5 in step 180. In step 190, this re-generated application code 3 may be executed in the distributed control system 5. This results in the industrial plant 1 being controlled according to the updated control strategy implemented in the re-generated application code 3.

This flow of information is further detailed in FIG. 2a for method 100a and in FIG. 2b for method 100b. According to FIG. 2a, state variables 6 from controllers 4 in the distributed control system 5, and from this control system 5 as a whole, are acquired. Also, interaction events 7 of at least one plant operator interacting with the control system 5 are acquired. Based on the state variables 6 and the one or more interaction events 7, it is determined in step 130 of method 100a whether this is indicative of the plant operator executing a task that is not sufficiently covered by the present engineering of the distributed control system 5. In step 140 of method 100a, the state variables 6 and interaction events 7 are mapped, using a machine learning model, a lookup table, or any other suitable instrument, to the sought amendment and/or augmentation 2a for the engineering tool 2. When this amendment and/or augmentation is implemented, the engineering tool 2 may generate new application code 3 that may then be run on controllers 4 in the distributed control system 5.

According to FIG. 2b, state variables 6 from controllers 4 in the distributed control system 5, and from this control system 5 as a whole, are acquired. Based on the state variables 6, at least one machine learning model 8 predicts one or more interaction events 7 that at least one plant operator is likely to initiate on the distributed control system 5. These predicted interaction events 7 are mapped to the sought amendment and/or augmentation 2a for the engineering tool 2 in step 160 of method 100b. When this amendment and/or augmentation is implemented, the engineering tool 2 may generate new application code 3 that may then be run on controllers 4 in the distributed control system 5.

FIG. 3 is a schematic flow chart of an embodiment of the method 200 for training a machine learning model 8. In step 210, records 6a of training input data with state variables 6 that characterize an operational state 1a of the at least one industrial plant 1 are provided. In step 220, labels 9 as to which interaction events 7 at least one plant operator has initiated in the distributed control system 5 in response to said operational states 1a are provided.

In step 230, the records 6a of training input data are mapped to predictions 7′ of one or more interaction events 7 that at least one plant operator will initiate in response to the operational states 1a in the training input data by the to-be-trained machine learning model 8. In step 240, it is rated, by means of a predetermined cost function 10, how well this prediction 7′ corresponds to the label 9 of the respective record 6a of training input data. In step 250, parameters 8a that characterize the behavior of the machine learning model 8 are optimized towards the goal that when further records 6a of training input data are processed by the machine learning model 8, this will result in a better rating 10a by the cost function 10. The finally obtained trained state of the parameters 8a is labelled with the reference sign 8a*.

In a further particularly advantageous embodiment, when the input data, and/or the interaction events, are mapped to the amendment and/or augmentation for the engineering tool, it may be determined that a function in a given control library accomplishes a result that is substantially similar to the result of an action or sequence of actions that has been detected and/or predicted. In this case, the detected and/or predicted action or sequence of actions may be substituted with a call to the determined function in the control library when generating the amendment and/or augmentation for the engineering tool. In this manner, knowledge that has already been condensed in a control library may be put to use in appropriate situations. For example, a plant operator may follow a certain manual protocol for bringing the temperature inside a vessel to a new target temperature, not knowing that for such a standard action, an automated protocol has already been laid down in the control library.

In a further particularly advantageous embodiment, the amendment and/or augmentation is configured to cause, when the application code is re-generated by the amended engineering tool and executed in the distributed control system, in a human-machine interface of the distributed control system, a new control element to appear such that a chain of actions that were previously executed by the plant operator repeatedly in sequence is executed upon actuation of this new control element; and/or a control element that previously required a first number of steps to access to move within the human-machine interface such that it requires a second, lower number of steps to access.

This enables the plant operator to accomplish the same intervention with fewer interactions between the plant operator and the human-machine interface of the distributed control system.

As discussed before, in a further particularly advantageous embodiment, the amendment and/or augmentation for the engineering tool augmentation is configured to cause, when the application code is re-generated by the amended engineering tool and executed in the distributed control system, one or more actions that were previously executed by the plant operator repeatedly starting from equal or substantially similar operating states to be executed automatically in response to a particular operating state occurring. This may relieve the plant operator from routine interventions, allowing him to focus on problem solving tasks instead.

In a further advantageous embodiment, an engineering tool is chosen that is configured to assemble the distributed control system from building blocks in a predetermined catalogue. At least one such building block is a programmable logic controller, PLC. The engineering tool is configured to generate application code that comprises control code for this PLC. When such an engineering tool is amended and/or augmented, the assembly of the plant from building blocks may remain unchanged, but the control code for the PLC may be recompiled, thereby upgrading it with new functionality.

Thus, either method may also further comprise re-generating, by the amended and/or augmented engineering tool, application code for the distributed control system. The re-generated application code may then be executed in the distributed control system. In this manner, the industrial plant is controlled according to the amended and/or augmented control strategy implemented in the re-generated application code.

Optionally, before the re-generating of the application code, a control engineer may be prompted for approval of the amendment and/or augmentation for the engineering tool. In this manner, the control engineer is made aware of what will change when the application code is re-generated the next time. Also, the control engineer is then able to check whether the proposed change violates any other constraints.

The invention also provides a computer-implemented method for training at least one machine-learning model for use in the second method described above. This method starts from records of training input data with state variables that characterize an operational state of the at least one industrial plant. Labels are provided as to which interaction events at least one plant operator has initiated in the distributed control system in response to said operational states. The to-be-trained machine learning model maps the records of training input data to predictions of one or more interaction events that at least one plant operator will initiate in response to the operational states in the training input data.

By means of a predetermined cost function, it is rated how well the prediction by the machine learning model corresponds to the label of the respective record of training input data. Parameters that characterize the behavior of the machine learning model are optimized towards the goal that when further records of training input data are processed by the machine learning model, this will result in a better rating by the cost function. In this manner, the prediction of plant operator interventions becomes more and more accurate as the training progresses.

For the labelling of the operational states with interaction events, actual interaction events gathered from the plant may, for example, be filtered according to whether these interaction events have resulted in successful or unsuccessful interventions by the plant operator. For example, interaction events may be graded according to any suitable metric as to how beneficial they have proved to be with respect to a given objective. The actual interaction events may, for example, be weighted according to these grades. Interaction events may, for example, be excluded from being included in labels if their grade is below a certain threshold.

In a particularly advantageous embodiment, the records of training input data are gathered from multiple industrial plants. In this manner, operator knowledge may be transferred at least between similar plants. For many types of plants, such as waste incineration plants, instances of these plants will differ from one another to some extent, but the basic functionality will be the same in all instances. Different instances of waste incineration plants may be fed with different compositions of waste. One waste incineration plant may be connected to a district heating network, while the other is not. But all instances have in common that there is a furnace of a certain type for combustion of the waste, and this combustion is controlled by manipulating a certain set of parameters.

In any given instance of the industrial plant, the training does not have to start from scratch. Rather, the machine learning model may first receive a generic training and be trained further in a more specific manner for a particular instance of the plant later. In this manner, when a large number of different instances of the plant is deployed, it is not necessary to repeat the generic part of the training time and time again.

The computer implementation of the methods described above implies that the methods may be embodied in a computer program. The invention therefore also provides a computer program with machine-readable instructions that, when executed by one or more computers, cause the one or more computers to perform one of the methods described above. The invention also provides a non-transitory machine-readable storage medium, and/or a download product, with the computer program. A download product is a product that may be sold in an online shop for immediate fulfillment by download. The invention also provides one or more computers with the computer program, and/or with the non-transitory machine-readable storage medium and/or download product.

### LIST OF REFERENCE SIGNS

1 industrial plant
1a operational state of industrial plant 1
2 engineering tool for distributed control system 5
2a amendment/augmentation for engineering tool 2
3 application code for distributed control system 5
4 controllers in distributed control system 5
5 distributed control system
6 state variables that characterize operational state 1a
6a training data record with state variables 6
7 interaction events between plant operator and control system 5
7′ prediction of interaction events 7 during training of model 8
8 machine learning model
8a parameters, characterize behavior of machine learning model 8
8a* finally trained state of parameters 8a
9 labels for training data records 6a
10 cost function for training of machine learning model 8
10a rating by cost function 10
100a method for obtaining amendment 2a based on patterns
100b method for obtaining amendment 2a based on interaction learning
105 choosing particular distributed control system 5
110 acquiring state variables 6
120 acquiring interaction events 7
130 determining execution of non-covered task
140 mapping input data to amendment/augmentation 2a
141 determining control library function
142 using library function instead of manual action
150 predicting interaction events 7
160 mapping predicted interaction events to amendment/augmentation 2a
161 determining control library function
162 using library function instead of manual action
170 submitting amendment 2a for approval by control engineer
180 re-generating application code 3
190 executing new application code 3
200 method for training machine learning model 8
210 providing records 6a of training input data
211 acquiring records 6a from multiple plants 1
220 providing labels 9
230 mapping records 6a to predictions 7′
240 rating prediction 7′ using cost function 10
250 optimizing parameters 8a

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for amending and/or augmenting an engineering tool that is configured to generate application code which, when executed on one or more controllers in a distributed control system of an industrial plant, causes the industrial plant to be controlled according to a control strategy that is implemented in the application code, the method comprising:
acquiring state variables that characterize an operational state of at least one industrial plant;
acquiring a set of interaction events of at least one plant operator interacting with the distributed control system of the industrial plant via a human-machine interface;
determining, based at least in part on the interaction events, the state variables and optionally given engineering information of the distributed control system as input data, whether one or more interaction events are indicative of the plant operator executing a task that is not sufficiently covered by the present engineering of the distributed control system;
and when this determination is positive, mapping the input data to an amendment and/or augmentation for the engineering tool that has generated the application code for the distributed control system such that, when the application code is re-generated by the amended and/or augmented engineering tool and executed in the distributed control system, the plant operator is likely to manually interact with the distributed control system less frequently, and/or to spend less time interacting with the distributed control system.

2. The method of claim 1, wherein the task that is not sufficiently covered by the present engineering of the distributed control system specifically comprises:
manually executing a solution to an operational problem that is not covered by the present engineering of the distributed control system; and/or
repeatedly executing one or more actions starting from equal or substantially similar operating states; and/or
accessing at least one functionality that requires at least a threshold number of steps to access with at least a threshold frequency.

3. A computer-implemented method for amending and/or augmenting an engineering tool that is configured to generate application code which, when executed on one or more controllers in a distributed control system of an industrial plant, causes the industrial plant to be controlled according to a control strategy that is implemented in the application code, the method comprising:
acquiring state variables that characterize an operational state of at least one industrial plant;
predicting, based on the state variables, using at least one trained machine learning model, one or more interaction events that at least one plant operator is likely to initiate on the distributed control system via a human-machine interface in response to said operational state; and
mapping the one or more predicted interaction events to an amendment and/or augmentation for the engineering tool that has generated the application code for the distributed control system such that, when the application code is re-generated by the amended and/or augmented engineering tool and executed in the distributed control system, the plant operator is likely to manually interact with the distributed control system less frequently, and/or to spend less time interacting with the distributed control system.

4. The method of claim 1, wherein the input data further comprises one or more of:
alarms and events reported by the distributed control system;
a topology model of the industrial plant;
a layout of a human-machine interface of the distributed control system; and
a control logic of the distributed control system.

5. The method of claim 1, wherein the mapping comprises:
determining a function in a given control library that accomplishes a result substantially similar to the result of a detected and/or predicted action or sequence of actions; and
substituting in the amendment and/or augmentation for the engineering tool the detected and/or predicted action or sequence of actions with a call to the determined function in the control library.

6. The method of claim 1, wherein the amendment and/or augmentation is configured to cause, when the application code is re-generated by the amended engineering tool and executed in the distributed control system, in a human-machine interface of the distributed control system:
a new control element to appear such that a chain of actions that were previously executed by the plant operator repeatedly in sequence is executed upon actuation of this new control element; and/or
a control element that previously required a first number of steps to access to move within the human-machine interface such that it requires a second, lower number of steps to access.

7. The method of claim 1, wherein the amendment and/or augmentation is configured to cause, when the application code is re-generated by the amended engineering tool and executed in the distributed control system, one or more actions that were previously executed by the plant operator repeatedly starting from equal or substantially similar operating states to be executed automatically in response to a particular operating state occurring.

8. The method of claim 1, wherein an engineering tool is chosen that is configured to assemble the distributed control system from building blocks in a predetermined catalogue, wherein at least one such building block is a programmable logic controller, PLC; and generate application code that comprises control code for this PLC.

9. The method of claim 1, further comprising:
re-generating, by the amended and/or augmented engineering tool, application code for the distributed control system; and
executing the re-generated application code in the distributed control system, thereby controlling the industrial plant according to the control strategy implemented in the re-generated application code.

10. The method of claim 9, further comprising: before the re-generating of the application code, prompting a control engineer for approval of the amendment and/or augmentation for the engineering tool.

11. The method of claim 3, wherein the input data further comprises one or more of:
alarms and events reported by the distributed control system;
a topology model of the industrial plant;
a layout of a human-machine interface of the distributed control system; and
a control logic of the distributed control system.

12. The method of claim 3, wherein the mapping comprises:
determining a function in a given control library that accomplishes a result substantially similar to the result of a detected and/or predicted action or sequence of actions; and
substituting in the amendment and/or augmentation for the engineering tool the detected and/or predicted action or sequence of actions with a call to the determined function in the control library.

13. The method of claim 3, wherein the amendment and/or augmentation is configured to cause, when the application code is re-generated by the amended engineering tool and executed in the distributed control system, in a human-machine interface of the distributed control system:
a new control element to appear such that a chain of actions that were previously executed by the plant operator repeatedly in sequence is executed upon actuation of this new control element; and/or
a control element that previously required a first number of steps to access to move within the human-machine interface such that it requires a second, lower number of steps to access.

14. The method of claim 3, wherein the amendment and/or augmentation is configured to cause, when the application code is re-generated by the amended engineering tool and executed in the distributed control system, one or more actions that were previously executed by the plant operator repeatedly starting from equal or substantially similar operating states to be executed automatically in response to a particular operating state occurring.

15. The method of claim 3, wherein an engineering tool is chosen that is configured to assemble the distributed control system from building blocks in a predetermined catalogue, wherein at least one such building block is a programmable logic controller, PLC; and generate application code that comprises control code for this PLC.

16. The method of claim 3, further comprising:
re-generating, by the amended and/or augmented engineering tool, application code for the distributed control system; and
executing the re-generated application code in the distributed control system, thereby controlling the industrial plant according to the control strategy implemented in the re-generated application code.

17. The method of claim 16, further comprising: before the re-generating of the application code, prompting a control engineer for approval of the amendment and/or augmentation for the engineering tool.

18. A computer-implemented method for training at least one machine-learning model, comprising:
providing records of training input data with state variables that characterize an operational state of at least one industrial plant;
providing labels as to which interaction events at least one plant operator has initiated in the distributed control system in response to said operational states;
mapping, by the machine learning model, the records of training input data to predictions of one or more interaction events that at least one plant operator will initiate in response to the operational states in the training input data;
rating, utilizing a predetermined cost function, how well the prediction by the machine learning model corresponds to the label of the respective record of training input data; and
optimizing parameters that characterize a behavior of the machine learning model towards the goal that when further records of training input data are processed by the machine learning model, this will result in a better rating by the cost function.

19. The method of claim 18, wherein the records of training input data are gathered from multiple industrial plants.
